(19) United States
(12) Patent Application Publication
(10) Pub. No.: US 2025/0062067 A1
(43) Pub. Date: Feb. 20, 2025

(54) PERMANENT MAGNET MANUFACTURING METHOD AND PERMANENT MAGNET

(71) Applicant: MINEBEA MITSUMI Inc., Nagano (JP)

(72) Inventors: Yu OKAWARA, Kitasaku-gun (JP); Haruhiro KOMURA, Kitasaku-gun (JP)

(21) Appl. No.: 18/720,751

(22) PCT Filed: Dec. 9, 2022
(86) PCT No.: PCT/JP2022/045475

§ 371 Date: Jun. 17, 2024

(30) Foreign Application Priority Data
Dec. 22, 2021 (JP) 2021-208389

(51) Int. Cl. H01F 41/02; B22F 3/12; H01F 7/02

(52) U.S. Cl. CPC H01F 41/0266; B22F 3/12; H01F 7/02

(57) ABSTRACT

A permanent magnet manufacturing method includes at least a magnetization target forming step of molding a magnetization target by applying a predetermined pressure to a magnet powder and a thermosetting resin, and a heating step of heating the magnet powder to the Curie point or higher while permanent magnets of a field magnet part are brought close to the magnetization target placed on a base member to magnetize the magnet powder and melting and curing the thermosetting resin to allow the magnetization target to fixedly adhere to the base member.

### CROSS REFERENCE TO RELATED APPLICATIONS

This application is a national stage entry of International Application No. PCT/JP2022/045475, filed on Dec. 9, 2022, which claims priority to Japanese Patent Application 2021-208389, filed on Dec. 22, 2021, which is incorporated herein by reference.

### TECHNICAL FIELD

The disclosure relates to a permanent magnet manufacturing method and a permanent magnet.

### BACKGROUND

Conventionally, a magnetic encoder used for detecting a position of a rotating device is known. When a compression-molded bonded magnet is used as a magnet for a magnetic encoder, a magnet powder and a thermosetting resin are first mixed, and then the magnet powder and the thermosetting resin are heated to a predetermined temperature to cure the thermosetting resin.

Next, the magnet powder is magnetized to produce a permanent magnet. Then, an adhesive made from a thermosetting resin is applied to a permanent magnet or a holder serving as a core metal, and the adhesive is heated to allow the permanent magnet to fixedly adhere to the holder, and thus a magnet for a magnetic encoder is manufactured. That is, in this method for manufacturing a magnet for a magnetic encoder, two sessions of a thermal curing step are required.

For example, in JP 2012-010553 A, using a rare-earth bonded magnet obtained by bonding a magnet powder made of a rare earth with a binder made from an epoxy resin to fit the magnet into a holder and then joining the magnet and the holder with an adhesive made from an epoxy resin is described.

### SUMMARY

The above-mentioned permanent magnet manufacturing method requires two sessions of the thermal curing step. However, since the thermal curing step requires a lot of time, there is room for further improvement in the above-described manufacturing method from the viewpoint of improvement in work efficiency.

In view of the above problems, the disclosure aims to provide a permanent magnet manufacturing method for improving work efficiency by fixing a permanent magnet to a core metal without using an adhesive.

In order to achieve the above object, a permanent magnet manufacturing method according to the disclosure includes at least a magnetization target forming step of molding a magnetization target by applying a predetermined pressure to a magnet powder and a thermosetting resin, and a heating step of heating the magnet powder to the Curie point or higher while permanent magnets of a field magnet part are brought close to the magnetization target placed at a base member to magnetize the magnet powder and melting and curing the thermosetting resin to allow the magnetization target to fixedly adhere to the base member.

The permanent magnet manufacturing method according to the disclosure can improve the work efficiency by fixing a permanent magnet to a core metal without using an adhesive.

### BRIEF DESCRIPTION OF DRAWINGS

FIG. 1 is a cross-sectional view illustrating a schematic configuration example of a magnetizer used in a permanent magnet manufacturing method according to an embodiment.

FIG. 2 is a cross-sectional view illustrating a part of a magnetization target forming step according to an embodiment.

FIG. 3 is a cross-sectional view illustrating a part of the magnetization target forming step according to an embodiment.

FIG. 4 is a perspective view of a magnetization target formed in the magnetization target forming step according to an embodiment.

FIG. 5 is a perspective view illustrating a state of the magnetization target disposed on a base member after a placing step according to an embodiment.

FIG. 6 is a cross-sectional view illustrating a state of the magnetization target disposed on the base member after the placing step according to an embodiment.

FIG. 7 is an exploded perspective view illustrating a relationship between a field magnet part, the magnetization target, and the base member in an axial direction in a heating step according to an embodiment.

FIG. 8 is a perspective view illustrating the field magnet part, the magnetization target, and the base member in the heating step according to an embodiment.

FIG. 9 is a cross-sectional view illustrating the heating step of a magnetizer according to an embodiment.

FIG. 10 is a cross-sectional view illustrating a cooling step of the magnetizer according to an embodiment.

FIG. 11 is a perspective view illustrating a magnetized magnetization target formed by the magnetizer according to an embodiment.

### DESCRIPTION OF EMBODIMENTS

A permanent magnetic manufacturing method and a permanent magnet according to an embodiment will be described with reference to the accompanying drawings. Further, this disclosure is not limited to the embodiments. Furthermore, the dimensional relationships between elements, ratios between the elements, and the like in the drawings may differ from reality. The drawings may include parts having different dimensional relationships and ratios. Furthermore, the contents described in one embodiment or modification example similarly apply in principle to other embodiments or modification examples.

### EMBODIMENT

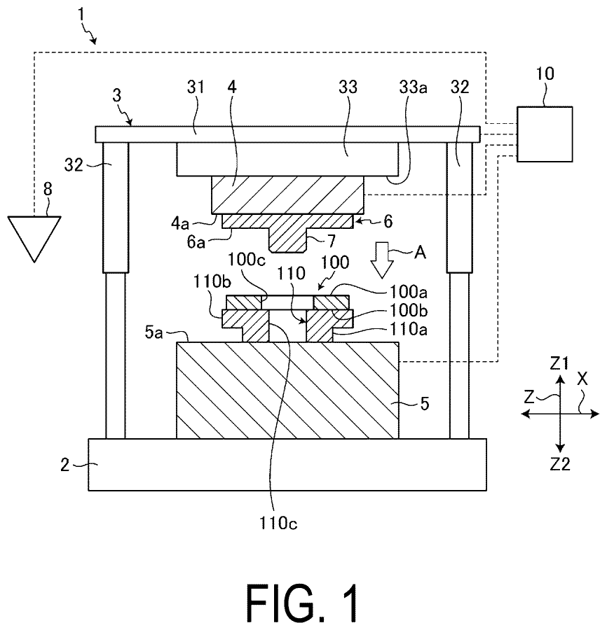

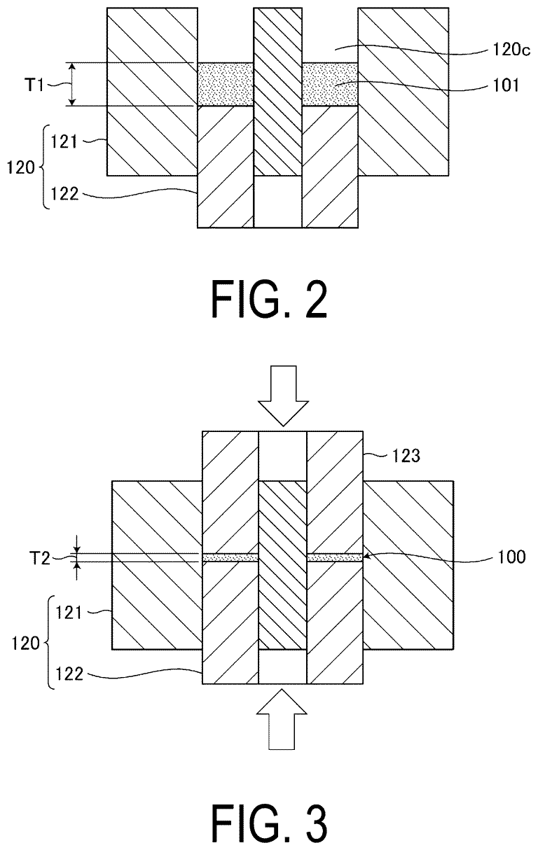

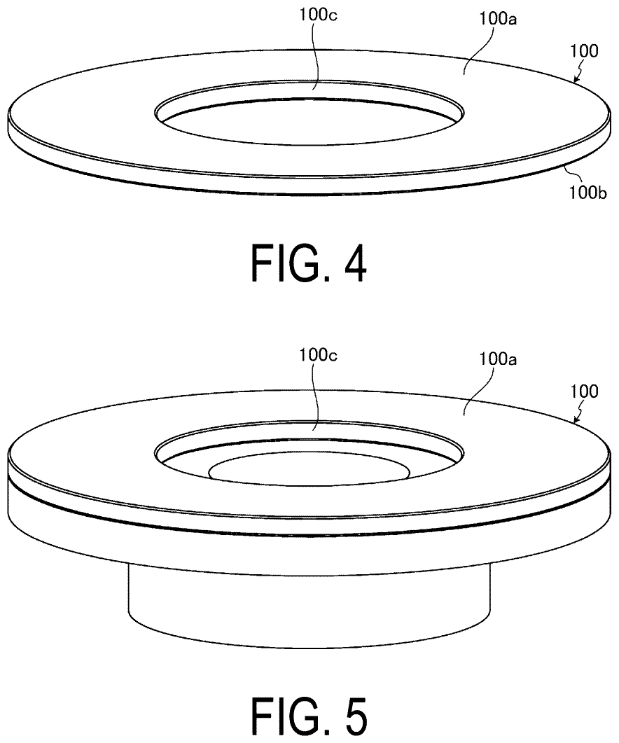

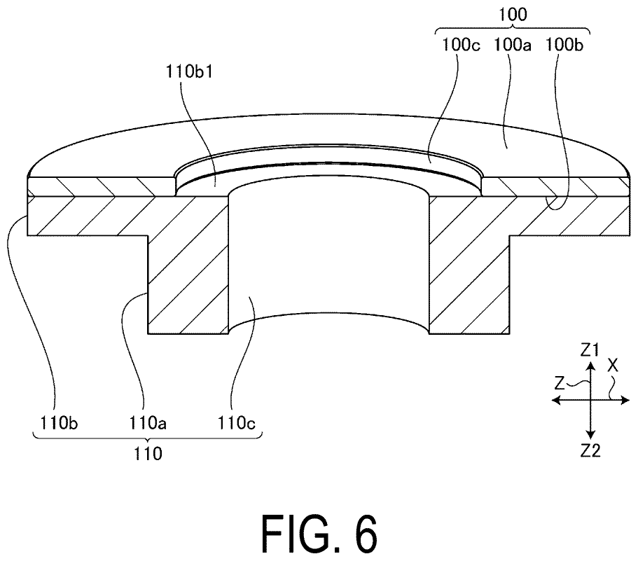

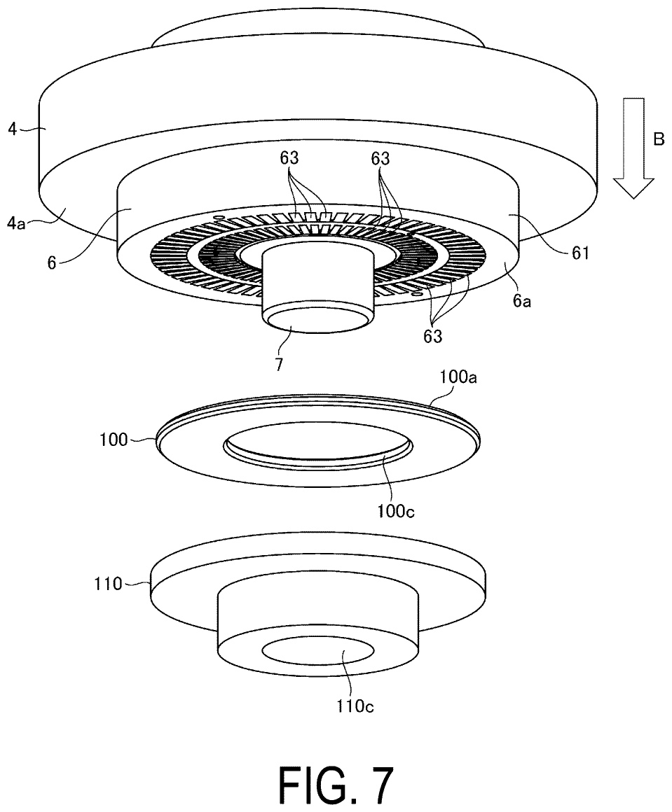

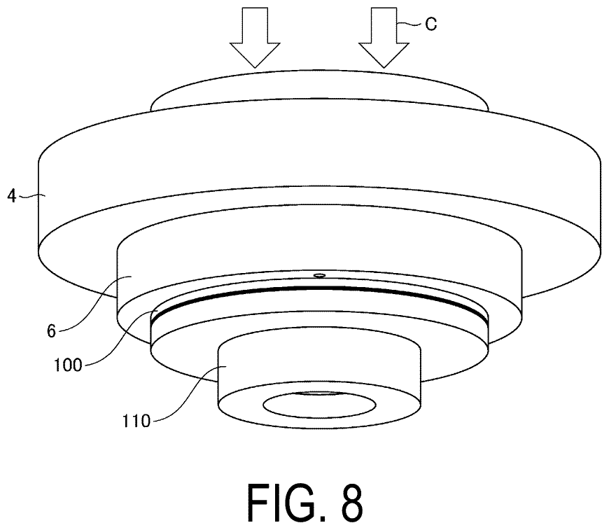

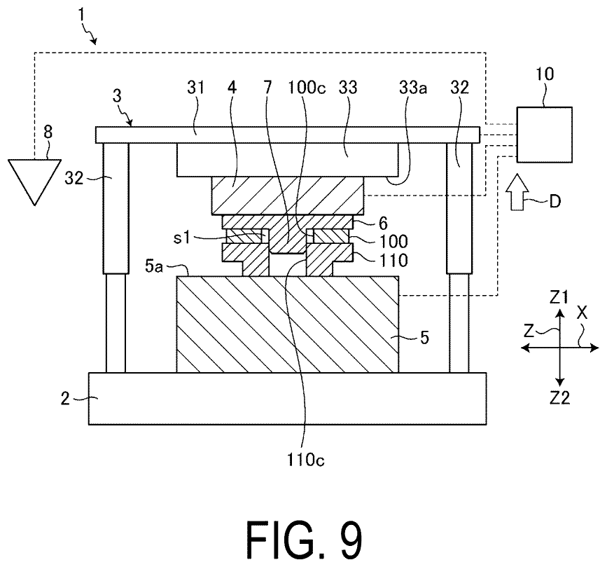

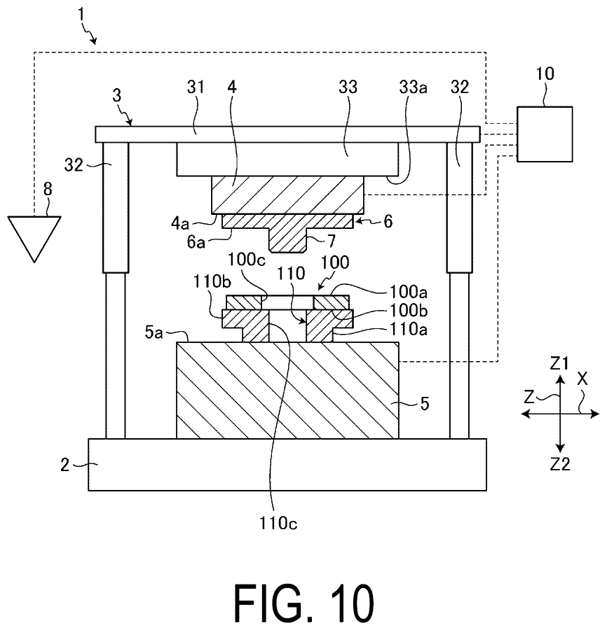

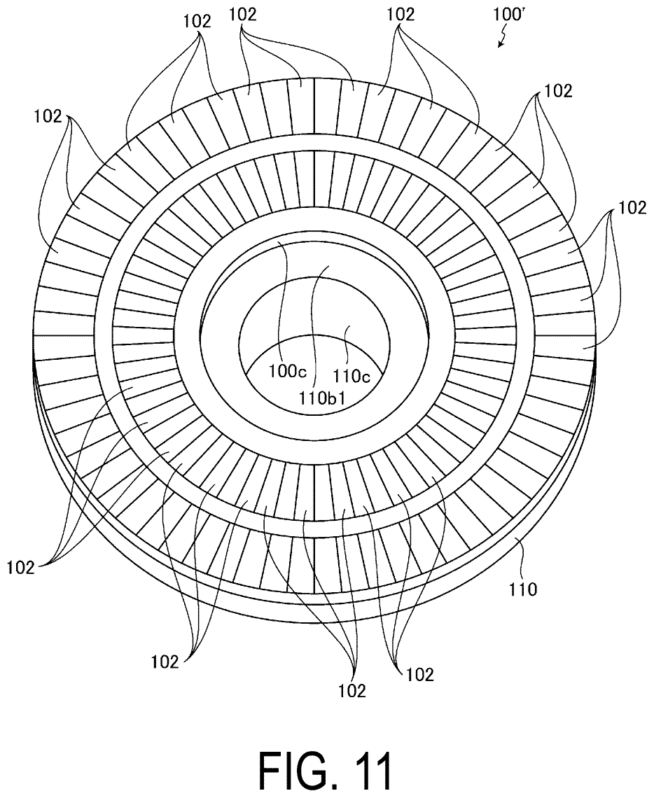

First, an example of a magnetizer 1 used in a permanent magnet manufacturing method according to an embodiment will be described. FIG. 1 is a cross-sectional view illustrating a schematic configuration example of the magnetizer 1 used in a permanent magnet manufacturing method according to an embodiment. FIG. 2 is a cross-sectional view illustrating a part of a magnetization target forming step according to an embodiment. FIG. 3 is a cross-sectional view illustrating a part of the magnetization target forming step according to an embodiment. FIG. 4 is a perspective view of a magnetization target 100 formed in the magnetization target forming step according to an embodiment. FIG. 5 is a perspective view illustrating a state of the magnetization target 100 disposed on a base member 110 after a placing step according to an embodiment. FIG. 6 is a cross-sectional view illustrating a state of the magnetization target 100 disposed on the base member 110 after the placing step according to an embodiment. FIG. 7 is an exploded perspective view illustrating a relationship between a field magnet part 6, the magnetization target 100, and the base member 110 in an axial direction in a heating step according to an embodiment. FIG. 8 is a perspective view illustrating the field magnet part 6, the magnetization target 100, and the base member 110 in the heating step according to an embodiment. FIG. 9 is a cross-sectional view illustrating the heating step of the magnetizer 1 according to an embodiment. FIG. 10 is a cross-sectional view illustrating a cooling step of the magnetizer 1 according to an embodiment. FIG. 11 is a perspective view illustrating a magnetized magnetization target 100′ formed by the magnetizer 1 according to an embodiment. Here, the X direction in each figure is the radial direction of the magnetization target 100 in the present embodiment. The Z direction is the axial direction and vertical direction of the magnetization target 100, the Z1 direction is an upward direction, and the Z2 direction is a downward direction.

The magnetizer 1 used in the permanent magnet manufacturing method according to the embodiment magnetizes the magnetization target 100 to manufacture a magnetized magnetization target 100′ as illustrated in FIG. 1. The magnetizer 1 includes a pedestal 2, a movement unit 3, a heating unit 4, a preheating unit 5, a field magnet part 6, a positioning pin 7, a cooling unit 8, and a control unit 10.

The pedestal 2 is a base portion of the magnetizer 1, and allows at least the movement unit 3, the heating unit 4, the preheating unit 5, the field magnet part 6, the positioning pin 7, the cooling unit 8, and the control unit 10 to be mounted.

The movement unit 3 moves the magnetization target 100 and the heating unit 4 with respect to each other between a non-heating position and a heating position in the axial direction. The movement unit 3 illustrated in FIG. 1 includes a ceiling plate 31, actuators 32, and a heating-unit mounting table 33. The ceiling plate 31 is disposed to be separated from the pedestal 2 in the axial direction, and allows the actuators 32 and the heating-unit mounting table 33 to be fixed. The actuators 32 move the ceiling plate 31 with respect to the pedestal 2 in the axial direction. The actuators 32 are, for example, linear motion mechanisms such as hydraulic cylinders receiving supply of electric power from an external power source, not illustrated, and driven and controlled by the control unit 10. Multiple actuators, for example, four actuators 32 are disposed between the pedestal 2 and the ceiling plate 31. The heating unit 4 is fixed to the heating-unit mounting table 33 being fixed to the lower-side surface of the ceiling plate 31.

The heating unit 4 heats the magnetization target 100 for magnetization. The heating unit 4 is made from a non-magnetic metal material, for example, non-magnetic stainless steel, or the like, and heats the magnetization target 100 to a temperature equal to or higher than the Curie point of the magnet powder constituting the magnetization target 100. The heating unit 4 according to the present embodiment is formed in a disc shape, and among both surfaces in the vertical direction, the upper-side surface is fixed to the heating-unit mounting table 33 of the movement unit 3, and the lower-side surface is a heating surface 4a. The heating surface 4a is formed to have an outer diameter larger than the outer shape of the field magnet part 6, and have an outer shape larger than the outer diameter of the magnetization target 100. In addition, the heating surface 4a always faces and is in contact with the upper-side surface of the field magnet part 6 in the vertical direction (axial direction). The heating unit 4 includes one or more heaters and receives supply of electric power from an external power source, not illustrated, and the temperature of the heating unit is controlled by the control unit 10.

The preheating unit 5 preliminarily heats the magnetization target 100. The preheating unit 5 is made from a non-magnetic metal material and heats the magnetization target 100 to a temperature lower than the Curie point (a temperature higher than room temperature) of the magnet powder constituting the magnetization target 100 before the heating unit 4 reaches the heating position to be described below. The preheating unit 5 of the present embodiment is formed in a cylindrical shape.

The preheating unit 5 heats, via the base member 110, the magnetization target 100 placed at the base member 110. Of both surfaces of the preheating unit 5 in the vertical direction, the lower-side surface is fixed to the pedestal 2, and the upper-side surface is a placement and heating surface 5a. The placement and heating surface 5a is formed to be larger than the outer diameter of the field magnet part 6, and is in contact with the base member 110. The preheating unit 5 receives supply of electric power from an external power source, not illustrated, has one or more heaters, and the temperature of the preheating unit is controlled by the control unit 10.

The field magnet part 6 generates a magnetic field for the magnetization target 100. The field magnet part 6 of the present embodiment magnetizes the magnetization target 100 in the axial direction, and includes a main body part 61, and field-magnet-part permanent magnets 63 (permanent magnets) serving as permanent magnets for magnetization. In the field magnet part 6 according to the present embodiment, for example, the field-magnet-part permanent magnets 63 are arranged in two rows in the radial direction to form a track formed by two rows of magnetized regions 102 to be described below.

The main body part 61 is made from a non-magnetic metal material and formed in a cylindrical shape. Among both surfaces of the main body part 61 in the vertical direction, the upper-side surface is fixed to the heating surface 4a, and as will be described below, the lower-side surface 6a comes into contact with the magnetization target 100 while the heating unit 4 is moved to the heating position. That is, in the magnetizer 1 according to the present embodiment, the lower-side surface 6a of the field magnet part 6 comes into contact with the upper-side surface 100a of the magnetization target 100 while the heating unit 4 is moved to the heating position. The positioning pin 7 protruding downward is attached to the center of the main body part 61 in the radial direction.

In the main body part 61, the field-magnet-part permanent magnets 63 formed in rectangular parallelepiped shapes are arranged at a uniform pitch in the circumferential direction. As the field-magnet-part permanent magnets 63, for example, SmCo sintered magnets can be used.

The field-magnet-part permanent magnets 63 are embedded at a lower end part of the main body part 61, generate a magnetic field for the magnetization target 100, and are formed, for example, in rectangular parallelepiped shapes. When viewed in the vertical direction, a plurality of field-magnet-part permanent magnets 63 are arranged at equal intervals in the circumferential direction of a concentric circle around the center of the main body part 61. In the main body part 61, a plurality of recessed parts are formed radially in the circumferential direction at predetermined intervals, and the plurality of field-magnet-part permanent magnets 63 are disposed at each of the plurality of recessed parts. The field-magnet-part permanent magnets 63 have two magnetic poles (an S pole and an N pole) at the upper side and the lower side, and are embedded in the main body part 61 such that the different magnetic poles alternate in the circumferential direction. Here, the magnetic polo (for example, the S pole) at the upper side of a field-magnet-part permanent magnet 63 is different from the magnetic pole (for example, the N pole) at the upper side of another field-magnet-part permanent magnet 63 adjacent in the circumferential direction, and the magnetic pole (for example, the N pole) at the lower side is different from the magnetic pole (for example, the S pole) at the lower side of the other field-magnet-part permanent magnet 63 adjacent in the circumferential direction. Further, in FIG. 7, although the field-magnet-part permanent magnets 63 are embedded in the main body part 61 to be exposed from the main body part 61 on the lower-side surface 6a, the field-magnet-part permanent magnets may be embedded inside the main body part 61 without being exposed on the lower-side surface 6a.

In addition, a shape of the field-magnet-part permanent magnets 63 is not limited to a rectangular parallelepiped shape, and may be any shape as long as the field-magnet-part permanent magnets can be embedded in the main body part 61. For example, the field-magnet-part permanent magnets 63 may have a fan shape in a top view. In addition, although FIG. 7 illustrates the field magnet part 6 with the field-magnet-part permanent magnets 63 being arranged in the concentric circles in two rows having different diameters in the field magnet part 6, the present embodiment is not limited to this configuration. For example, in the present embodiment, one row of the field-magnet-part permanent magnets 63 may be arranged on a circle centered on the axial center of the main body part 61.

The positioning pin 7 determines a position of the magnetization target 100 with respect to the field magnet part 6 in the radial direction, and is inserted into a through hole 100c of the magnetization target 100 to be described below. The positioning pin 7 is fixed to the field magnet part 6.

The cooling unit 8 cools the magnetization target 100 heated by the heating unit 4. The cooling unit 8 of the present embodiment is fixed to the pedestal 2 by a fixing member, not illustrated, and emits air toward the magnetization target 100. The cooling unit 8 is, for example, an air cooling fan, a compressor supplying compressed air, or the like, and cools the heated magnetization target 100 not by natural-air cooling but by forced-air cooling with high cooling efficiency. The cooling unit 8 receives supply of electric power from an external power source, not illustrated, and air blowing is controlled by the control unit 10.

The control unit 10 controls each unit of the magnetizer 1 and controls the magnetizer 1 in order to magnetize the magnetization target 100. To describe more specifically, the control unit 10 controls the movement unit 3, the heating unit 4, the preheating unit 5, and the cooling unit 8.

The control unit 10 controls driving of the movement unit 3 to move the heating unit 4 and the field magnet part 6 with respect to the magnetization target 100 placed at the base member 110 to the non-heating position and the heating position. Here, at the non-heating position (non-contact), the lower-side surface 6a of the field magnet part 6 is separated from the magnetization target 100 in the axial direction and the magnetization target 100 is not heated by the heating unit 4 (see FIG. 1). On the other hand, at the heating position, the field magnet part 6 gets close to the magnetization target 100 in the axial direction (in the present embodiment, the lower-side surface 6a of the field magnet part 6 comes into contact with the magnetization target 100) and the magnetization target 100 is heated by the heating unit 4 (see FIG. 9).

The control unit 10 controls a temperature of the heating unit 4 to heat the heating unit 4 to reach a heating temperature equal to or higher than the Curie point of the magnet powder constituting the magnetization target 100. The heating unit 4 of the present embodiment is controlled by the control unit 10 such that the heating unit 4 is heated to a temperature equal to or higher than the Curie point of the magnet powder and equal to or lower than 350° C. at the heating position. At the heating temperature, deterioration of magnetic characteristics of the magnet powder constituting the magnetization target 100 and deterioration of a thermosetting resin to be described below can be curbed. Further, the heating temperature is lower than the Curie point of the field-magnet-part permanent magnets 63. When the field magnet part 6 comes into contact with the magnetization target 100, the control unit 10 of the magnetizer 1 according to the present embodiment performs control such that the field magnet part 6 is pressed against the magnetization target 100 (the field magnet part 6 is pressed against the magnetization target 100 in the direction of arrows C illustrated in FIG. 8). To describe more specifically, when the field magnet part 6 comes into contact with the magnetization target 100, the control unit 10 controls driving of the movement unit 3 such that a pressing force to protect the magnetization target 100 from damage is obtained. As a result, damage to the magnetization target 100 can be curbed, and the magnetization target 100 and the field magnet part 6 can be in a uniform contact state. In addition, the control unit 10 controls a temperature of the preheating unit 5 such that the preheating unit 5 is heated to a preheating temperature lower than the Curie point of the magnet powder constituting the magnetization target 100 before the heating unit 4 reaches the heating position. In the present embodiment, before the preheating unit 5 reaches the heating position, the control unit 10 heats the preheating unit 5 such that the temperature is lower than the Curie point by 30° C. or higher and is higher than or equal to 150° C.

Then, the control unit 10 performs a heating step of heating the magnet powder to the Curie point or higher of the magnet powder of the magnetization target 100 through heating by the heating unit 4. The heating step is carried out for approximately one minute. Due to this heating step, magnetization of the magnetization target 100, curing of the magnetization target 100, and fixed adhesion of the magnetization target 100 to the base member 110 are performed at the same time. That is, after the magnetization target 100 is magnetized by the field-magnet-part permanent magnets 63 and the thermosetting resin contained in the magnetization target 100 is melted and then cured in the heating step, the magnetization target 100 is allowed to fixedly adhere to the base member 110 and the magnetization target 100 is magnetized to become a permanent magnet. In particular, because the thermosetting resin contained in the magnetization target 100 is melted and seeps into the base member 110 in the heating step, the magnetization target 100 is fixedly adhered to the base member 110. More specifically, the magnetization target 100 according to the present embodiment is allowed to fixedly adhere to the base member 110 only due to the cured thermosetting resin. Thereafter, the control unit 10 moves the heating unit 4 and the field magnet part 6 in the upward direction (the direction of arrow D illustrated in FIG. 9). Then, by controlling the temperature of the cooling unit 8, the heated magnetization target 100 is cooled (see FIG. 9).

Here, the magnetization target 100 is formed in a ring shape and has an upper-side surface 100a and a lower-side surface 100b as both surfaces in the vertical direction (axial direction), and the through hole 100c as illustrated in FIG. 4.

The magnetization target 100 is a rare-earth iron-based magnet before magnetization, and in the present embodiment, for example, is formed by mixing magnet powder containing neodymium (Nd—Fe—B) being a magnetically isotropic rare earth iron-based magnet, and a thermosetting resin, for example, an epoxy resin, at predetermined ratios. The magnetization target 100 is a so-called large magnetization target 100 rather than a small magnetization target 100, and formed in a ring shape having an outer diameter of 10 mm or more, preferably an outer diameter of 15 mm or more and 50 mm or less as an example.

The size of the through hole 100c of the magnetization target 100 according to the present embodiment in the radial direction is larger than the size of the positioning pin 7 in the radial direction, and a clearance s1 is formed between the inner circumferential surface of the through hole 100c of the magnetization target 100 and the outer circumferential surface of the positioning pin 7 in the radial direction with the heating unit 4 disposed at the heating position (see FIG. 9). In addition, the size of the through hole 100c of the magnetization target 100 according to the present embodiment in the radial direction is larger than the size of a positioning hole part 110c, to be described below, of the base member 110 in the radial direction.

As illustrated in FIG. 6, the base member 110 includes a base member lower part 110a, a base member flange part 110b, and the positioning hole part 110c. The base member 110 is a so-called core metal or holder formed of, for example, a non-magnetic metal material. For example, the base member 110 is a threneteres steel such as SUS304. The base member lower part 110a is formed in a ring shape having a size in the radial direction smaller than the size of the base member flange part 110b. The base member flange part 110b is formed to protrude radially outward from the upper end part of the base member lower part 110a. In addition, the base member flange part 110b has an upper end part 110b1. The magnetization target 100 is placed at the upper end part. The upper end part 110b1 is located on one side in the vertical direction (axial direction). In addition, the upper end part 110b1 does not protrude to either side in the vertical direction. Furthermore, the contact surface of the base member 110 with the magnetization target 100 (i.e., the upper end part 110b1) preferably has a high degree of surface roughness for the purpose of improving the adhesive strength. For example, the upper end part 110b1 may be subjected to processing aiming at an anchor effect such as knurling processing.

Next, a method of magnetizing the magnetization target 100 by the magnetizer 1 according to the present embodiment will be described. The control unit 10 applies a mold releasing agent to at least one of the lower-side surface 6a of the field magnet part 6 and the upper-side surface 100a of the magnetization target 100 in advance (application step). As the mold releasing agent, for example, boron nitride or a heat-resistant fluorine-based releasing material can be used.

First, the control unit 10 produces a mixture 101 containing a magnet powder (for example, a rare-earth magnet powder) adjusted to have a predetermined particle size and a thermosetting resin (for example, an epoxy resin) (mixture forming step). To describe more specifically, the control unit 10 mixes the magnet powder and the thermosetting resin at predetermined ratios. As the rare earth magnet powder, for example, an Nd—Fe—B-based magnet powder can be used.

In the permanent magnet manufacturing method according to the present embodiment, for example, an Nd—Fe—B-based magnet powder obtained by melting an Nd—Fe—B-based magnet alloy and pulverizing a ribbon of the Nd—Fe—B-based magnet alloy prepared by a super rapid cooling method to adjust the particle size to a predetermined particle size, and an epoxy-based thermosetting resin are used. For example, the thermosetting resin is added to the magnet powder at a concentration of 2.5 percent by weight of the magnet powder to be blended. Then, the control unit 10 puts the mixture 101 into a cavity 120c of a mold 120 including a mold main body 121 and a mold moving unit 122 as illustrated in FIG. 2.

Next, the control unit 10 moves the upper mold downward as illustrated in FIG. 3 to apply, by using the upper mold and the lower mold, pressure to the mixture 101 containing the magnet powder and the thermosetting resin mixed at predetermined ratios, and thus the magnetization target 100 made from the magnet powder and the thermosetting resin is formed as illustrated in FIG. 3 (magnetization target forming step).

In the permanent magnet manufacturing method according to the present embodiment, the ring-shaped (in other words, doughnut-shaped) magnetization target 100 is formed by pressurizing the mixture 101 placed in the cavity 120c of the mold 120 at a predetermined pressure (molding surface pressure of 5 to 10 ton/cm²). The formed magnetization target 100 is a so-called green body.

In the permanent magnet manufacturing method according to the present embodiment, the mixture 101 illustrated in FIG. 2 obtained by mixing magnet powder and thermosetting resin at predetermined ratios before the pressurization has a thickness T1 in the vertical direction (axial direction) of, for example, 5 mm. On the other hand, a thicknesses T2 in the vertical direction (axial direction) of the magnetization target 100 illustrated in FIGS. 3 and 4 formed by pressurization is, for example, 1 to 2 mm.

Next, the control unit 10 places the magnetization target 100 on the upper end part 110b1 of the base member 110 as illustrated in FIGS. 5, 6, and 7. At this time, a guide member, not illustrated, for aligning the position of the magnetization target 100 in the radial direction with respect to the base member 110 is used to align the positions of the through hole 100c of the magnetization target 100 with the positioning hole part 110c of the base member 110.

Next, the control unit 10 places the base member 110 having the magnetization target 100 placed at the upper end part 110b1 on the placement and heating surface 5a. At this time, by using the guide member, not illustrated, for positioning the positioning hole part 110c of the base member 110 and the positioning pin 7, the positioning hole part 110c and the positioning pin 7 are set to face each other in the vertical direction (axial direction).

Next, the control unit 10 starts heating of the heating unit 4 and the preheating unit 5. Here, the control unit 10 heats the heating unit 4 to the heating temperature and heats the preheating unit 5 to the preheating temperature. Next, having the through hole 100c of the magnetization target 100 illustrated in FIG. 1 and the positioning pin 7 face each other in the axial direction, an operator moves the heating unit 4 and the field magnet part 6 illustrated in FIG. 1 in the downward direction (indicated by arrow A in the same drawing).

Next, the control unit 10 drives the movement unit 3 to move the heating unit 4 illustrated in FIG. 7 (arrow B in the same drawing). That is, after the heating unit 4 reaches the predetermined heating temperature and the magnetization target 100 reaches the predetermined preheating temperature at a non-heating position, the control unit 10 according to the present embodiment causes the heating unit 4 to be moved to the heating position with respect to the magnetization target 100 and starts heating the preheated magnetization target 100 with the lower-side surface 6a of the field magnet part 6 in contact with the upper-side surface 100a of the magnetization target 100 (heating step). Further, when the heating unit 4 is moved from the non-heating position to the heating position by the movement unit 3, the control unit 10 ends the heating by the preheating unit 5, that is, turns off the temperature control. In addition, the positioning of the field magnet part 6 and the base member 110 is performed by using the positioning pin 7 attached to the field magnet part 6 and the positioning hole part 110c of the base member 110. In addition, in the heating step having the positioning pin 7 engaged with the positioning hole part 110c, the clearance s1 is formed between the inner circumferential surface of the through hole 100c and the outer circumferential surface of the positioning pin 7 (see FIG. 9).

Next, the control unit 10 causes the magnetization target 100 to be heated to the Curie point or higher having the lower-side surface 6a of the field magnet part 6 being in contact with the magnetization target 100. Next, after a predetermined time elapses at the heating position, the control unit 10 causes the movement unit 3 to move the heating unit 4 illustrated in FIG. 9 from the heating position to the non-heating position with respect to the magnetization target 100 (indicated by the arrow D in the same drawing). Here, the above-mentioned predetermined time means a sufficient time for the magnetization target 100 to reach the Curie point or higher.

Next, the control unit 10 causes the cooling unit 8 to cool the magnetization target 100 at the non-heating position as illustrated in FIG. 10. Next, after a predetermined time elapses from the start of cooling by the cooling unit 8 at the non-heating position, the control unit 10 ends the cooling by the cooling unit 8. Here, the above-mentioned predetermined time means a sufficient time for the magnetization target 100 to reach a temperature from the Curie point or higher to a temperature lower than the Curie point, and preferably, a temperature 50° C. lower than the Curie point.

Next, the control unit 10 takes out a magnetized magnetization target 100′. When the magnetizer 1 newly magnetizes the magnetization target 100, the control unit 10 starts heating the preheating unit 5 since the heating unit 4 has already been heated.

As described above, the magnetizer 1 according to the present embodiment magnetizes the magnetization target 100 by increasing the temperature of the magnetization target 100 from a temperature lower than the Curie point to the Curie point or higher and decreasing the temperature from the Curie point or higher to a temperature lower than the Curie point while the magnetization magnetic field is applied by the field magnet part 6. As a result, the magnetizer 1 manufactures the magnetized magnetization target 100′ from the magnetization target 100 as illustrated in FIG. 11. The magnetized regions 102 are formed by the field-magnet-part permanent magnets 63 in the magnetized magnetization target 100′. The magnetized magnetization target 100′ according to the present embodiment is a permanent magnet having the magnetized regions 102 having alternately different magnetic poles on the upper surface in the circumferential direction, and a permanent magnet magnetized with two rows of multipoles in a ring shape at least in the upper-side surface 100a.

In addition, the magnetized magnetization target 100′ formed in the manufacturing method according to the present embodiment is used for rotating devices such as a motor, an encoder, and the like. To describe more specifically, the magnetized magnetization target 100′ is used in, for example, an encoder (magnetic encoder) or a motor (axial gap motor). As an example, the magnetization target 100′ used in a magnetic encoder is used in, for example, a position detection sensor provided adjacent to a shaft rotating around the shaft core and detecting a rotation position of the shaft.

A permanent magnet manufacturing method according to the present embodiment includes the following steps. The permanent magnet manufacturing method includes the magnetization target forming step of molding the magnetization target 100 by applying a predetermined pressure to the magnet powder and the thermosetting resin, and a heating step of heating the magnet powder to the Curie point or higher while the field-magnet-part permanent magnets 63 are brought close to the magnetization target 100 placed at the base member 110 to magnetize the magnet powder and melting and curing the thermosetting resin to allow the magnetization target 100 to fixedly adhere to the base member 110. Thus, according to the permanent magnet manufacturing method according to the present embodiment, it is possible to allow the magnetization target 100 to fixedly adhere to the base member 110 by magnetizing the magnet powder and melting and curing the thermosetting resin in one session of the heating step. Thus, according to the permanent magnet manufacturing method according to the present embodiment, there is no need to perform the heating step twice, and thus the work efficiency at the time of manufacturing can be improved. In addition, since the heating step is performed only once in the permanent magnet manufacturing method according to the present embodiment, the thermal history of the permanent magnet can be reduced. Furthermore, since the magnetization target 100 can be allowed to fixedly adhere to the base member 110 by the cured thermosetting resin in the permanent magnet manufacturing method according to the present embodiment, a separate adhesive does not need to be used.

The permanent magnet manufacturing method according to the present embodiment includes the following step. The permanent magnet manufacturing method according to the present embodiment includes the application step of applying a mold releasing agent to at least one of the contact surface of the field magnet part 6 and the contact surface of the magnetization target 100 before the heating step. Therefore, according to the permanent magnet manufacturing method according to the present embodiment, the magnetization target 100 can be prevented from adhering to the field magnet part 6 after the heating step.

The permanent magnet manufacturing method according to the present embodiment includes the following step. In the permanent magnet manufacturing method according to the present embodiment, the thickness T2 of the magnetization target 100, in the vertical direction, formed in the magnetization target forming step is 1 to 2 mm. For this reason, in the permanent magnet manufacturing method according to the present embodiment, the thickness T2 of the magnetization target 100 in the vertical direction is small, and the amount of uncured thermosetting resin after the heating step is small.

The permanent magnet manufacturing method according to the present embodiment includes the following step. In the heating step having the positioning pin 7 engaged with the positioning hole part 110c, the clearance s1 is formed between the inner circumferential surface of the through hole 100c and the outer circumferential surface of the positioning pin 7. Therefore, in the heating step in the permanent magnet manufacturing method according to the present embodiment, the thermally expanded positioning pin 7 can be prevented from pressing the magnetization target 100, and the thermally expanded base member 110 can be prevented from pressing the magnetization target 100. As a result, in the permanent magnet manufacturing method according to the present embodiment, excessive thermal stress can be prevented from being applied to the magnetization target 100 by the heated base member 110 or the heated positioning pin 7.

The permanent magnet (magnetized magnetization target 100′) according to the present embodiment includes the following configuration. The upper end part 110b1 of the base member 110 allowing the magnetization target 100 to fixedly adhere is a flat surface not protruding to either side in the vertical direction. Therefore, the permanent magnet according to the present embodiment can prevent the thermally expanded base member 110 from pressing the magnetization target 100 in the manufacturing process. As a result, in the permanent magnet according to the present embodiment, excessive thermal stress can be prevented from being applied to the magnetization target 100 by the base member 110.

The permanent magnet (magnetized magnetization target 100′) according to the present embodiment includes the following configuration. The size of the through hole 100c in the radial direction is larger than the size of the positioning hole part 110c in the radial direction. For this reason, the permanent magnet according to the present embodiment can prevent the positioning pin 7 engaged with the positioning hole part 110c from pressing the magnetization target 100 due to thermal expansion in the manufacturing process. As a result, in the permanent magnet according to the present embodiment, excessive thermal stress can be prevented from being applied to the magnetization target 100 by the positioning pin 7.

Further, in the permanent magnet manufacturing method described above, forming the mixture 101 from the magnet powder and the thermosetting resin has been described. However, the permanent magnet manufacturing method according to the present embodiment is not limited to the above configuration. For example, in the permanent magnet manufacturing method, the mixture 101 may be formed from the magnet powder, the thermosetting resin, and the lubricant. As the lubricant, for example, calcium stearate can be used. In addition, a lubricant can be added to the magnet powder at a concentration of 0.25 percent by weight of the weight of the magnet powder. If the lubricant is added to the mixture 101, it is possible to suppress adhesion of the magnetized magnetization target 100′ to the lower-side surface 6a of the field magnet part 6 when the field magnet part 6 is moved upward together with the heating unit 4.

In addition, the Nd—Fe—B-based magnet powder is described to be used as the rare-earth magnet powder in the above-described permanent magnet manufacturing method. The permanent magnet manufacturing method according to the present embodiment is not limited to this configuration, and an Sm—Fe—N-based magnet powder or the like can be used as the rare earth magnet powder.

Furthermore, preferably, the magnetizer 1 is disposed inside a chamber, not illustrated, and a vacuum is created inside the chamber, or the chamber is filled with an inert gas.

In addition, when the Nd—Fe—B-based magnet powder is used as the magnet powder, it is preferable to apply a rust prevention treatment to the magnetized magnetization target 100′.

Furthermore, the disclosure is not limited by the embodiments described above. A configuration obtained by appropriately combining the above-mentioned components is also included in the disclosure. Further effects and modification examples can be easily derived by a person skilled in the art. Thus, a wide range of aspects of the disclosure is not limited to the embodiments described above and the disclosure may be modified in various ways.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A permanent magnet manufacturing method comprising at least:
a magnetization target forming step of molding a magnetization target by applying a predetermined pressure to a magnet powder and a thermosetting resin; and
a heating step of heating the magnet powder to the Curie point or higher while a permanent magnet of a field magnet part is brought close to the magnetization target placed at a base member to magnetize the magnet powder and melting and curing the thermosetting resin to fixedly adhere the magnetization target to the base member.

2. The permanent magnet manufacturing method according to claim 1, comprising
an application step of applying a mold releasing agent to at least one of a contact surface of the field magnet part or a contact surface of the magnetization target before the heating step.

3. The permanent magnet manufacturing method according to claim 1, wherein a thickness, in a vertical direction, of the magnetization target formed in the magnetization target forming step is 1 to 2 mm.

4. The permanent magnet manufacturing method according to claim 1,
wherein
the field magnet part includes a positioning pin protruding downward,
the base member includes a positioning hole part fitted with the positioning pin, and an upper end part not protruding to either side in a vertical direction, the magnetization target is placed at the upper end part,
the magnetization target has a through hole, the positioning pin can be inserted into the through hole, and
in the heating step including engagement of the positioning pin and the positioning hole part, a clearance is formed between an inner circumferential surface of the through hole and an outer circumferential surface of the positioning pin.

5. A permanent magnet comprising:
a magnetization target formed in a ring shape and having a magnetized region and a non-magnetized region; and
a base member fixedly adhered to the magnetization target,
wherein an upper end part of the base member fixedly adhered to the magnetization target is a flat surface not protruding to either side in a vertical direction.

6. The permanent magnet according to claim 5, wherein
the base member includes a positioning hole part fitted with a positioning pin of a field magnet part,
the magnetization target has a through hole penetrating the magnetization target in the vertical direction, the positioning pin can be inserted into the through hole, and
a size of the through hole in a radial direction is larger than a size of the positioning hole part in the radial direction.

7. The permanent magnet according to claim 5, wherein the magnetization target is fixedly adhered to the base member only by a cured thermosetting resin.
